(19) United States
(12) Patent Application Publication
(10) Pub. No.: US 2025/0358051 A1
(43) Pub. Date: Nov. 20, 2025

(54) USER EQUIPMENT CAPABILITIES FOR HYBRID AUTOMATIC REPEAT REQUESTS

(71) Applicant: QUALCOMM Incorporated, San Diego, CA (US)

(72) Inventors: Kianoush HOSSEINI, San Diego, CA (US); Jae Ho RYU, San Diego, CA (US); Mostafa KHOSHNEVISAN, San Diego, CA (US); Hobin KIM, San Diego, CA (US); Peter GAAL, San Diego, CA (US)

(21) Appl. No.: 18/667,633

(22) Filed: May 17, 2024

(51) Int. Cl. H04L 1/1812; H04L 1/1867

(52) U.S. Cl. CPC H04L 1/1812; H04L 1/1874

(57) ABSTRACT

Various aspects of the present disclosure generally relate to wireless communication. In some aspects, a user equipment (UE) may transmit a UE capability report indicating a maximum quantity of hybrid automatic repeat request (HARQ) processes supported across a plurality of component carriers (CCs) or indicating a HARQ buffering capability. The UE may receive a HARQ process quantity configuration in accordance with the UE capability report. Numerous other aspects are described.

### FIELD OF THE DISCLOSURE

Aspects of the present disclosure generally relate to wireless communication and specifically relate to techniques, apparatuses, and methods for user equipment capabilities for hybrid automatic repeat requests.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some cases, the maximum quantity of hybrid automatic repeat request (HARQ) processes that a network node can configure on each cell for a user equipment (UE) is fixed. Increasing the quantity of HARQ processes may prevent delays that can occur in scheduling by the network node, but can also occupy additional memory at the UE. Memory limitations may also prevent the UE from supporting large quantities of component carriers (CCs) and thereby improving peak throughput, even in cases where the UE would otherwise have the capability to support the large quantity of CCs.

Various aspects relate generally to UE capabilities for HARQ. Some aspects more specifically relate to HARQ buffer management for multi-carrier operation. In some aspects, the UE may report a quantity of HARQ processes that is supported by the UE across all configured CCs. In some aspects, the UE may report a HARQ buffering capability of the UE. In this way, the quantity of HARQ processes may be increase without requiring additional memory at the UE and/or a larger number of CCs and/or bandwidth may be support without impacting memory requirements at the UE for HARQ management.

Some aspects described herein relate to an apparatus for wireless communication at a UE. The apparatus may include one or more memories and one or more processors coupled to the one or more memories. The one or more processors may be configured to cause the UE to transmit a UE capability report indicating a maximum quantity of HARQ processes supported across a plurality of CCs or indicating a HARQ buffering capability. The one or more processors may be configured to cause the UE to receive a HARQ process quantity configuration in accordance with the UE capability report.

Some aspects described herein relate to an apparatus for wireless communication at a network node. The apparatus may include one or more memories and one or more processors coupled to the one or more memories. The one or more processors may be configured to cause the network node to receive a UE capability report indicating a maximum quantity of HARQ processes supported across a plurality of CCs or indicating a HARQ buffering capability. The one or more processors may be configured to cause the network node to transmit a HARQ process quantity configuration in accordance with the UE capability report.

Some aspects described herein relate to a method of wireless communication performed by a UE. The method may include transmitting a UE capability report indicating a maximum quantity of HARQ processes supported across a plurality of CCs or indicating a HARQ buffering capability. The method may include receiving a HARQ process quantity configuration in accordance with the UE capability report.

Some aspects described herein relate to a method of wireless communication performed by a network node. The method may include receiving a UE capability report indicating a maximum quantity of HARQ processes supported across a plurality of CCs or indicating a HARQ buffering capability. The method may include transmitting a HARQ process quantity configuration in accordance with the UE capability report.

Some aspects described herein relate to an apparatus for wireless communication. The apparatus may include means for transmitting a capability report indicating a maximum quantity of HARQ processes supported across a plurality of CCs or indicating a HARQ buffering capability. The apparatus may include means for receiving a HARQ process quantity configuration in accordance with the capability report.

Some aspects described herein relate to an apparatus for wireless communication. The apparatus may include means for receiving a UE capability report indicating a maximum quantity of HARQ processes supported across a plurality of CCs or indicating a HARQ buffering capability. The apparatus may include means for transmitting a HARQ process quantity configuration in accordance with the UE capability report.

Some aspects described herein relate to a non-transitory computer-readable medium that stores a set of instructions for wireless communication by a UE. The set of instructions, when executed by one or more processors of the UE, may cause the UE to transmit a UE capability report indicating a maximum quantity of HARQ processes supported across a plurality of CCs or indicating a HARQ buffering capability. The set of instructions, when executed by one or more processors of the UE, may cause the UE to receive a HARQ process quantity configuration in accordance with the UE capability report.

Some aspects described herein relate to a non-transitory computer-readable medium that stores a set of instructions for wireless communication by a network node. The set of instructions, when executed by one or more processors of the network node, may cause the network node to receive a UE capability report indicating a maximum quantity of HARQ processes supported across a plurality of CCs or indicating a HARQ buffering capability. The set of instructions, when executed by one or more processors of the network node, may cause the network node to transmit a HARQ process quantity configuration in accordance with the UE capability report.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating examples of carrier aggregation, in accordance with the present disclosure.

FIG. 5 is a diagram illustrating an example of flexible spectrum integration (FSI), in accordance with the present disclosure.

FIG. 6 is a diagram illustrating an example of FSI with single-physical-shared-channel transport block (TB) scheduling and mapping, in accordance with the present disclosure.

FIG. 7 is a diagram illustrating an example of FSI with multi-sub-band scheduling downlink control information, in accordance with the present disclosure.

FIG. 8 is a diagram illustrating examples of hybrid automatic repeat request process quantity configuration, in accordance with the present disclosure.

FIG. 9 is a diagram illustrating an example associated with UE capabilities for HARQ, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Carrier aggregation (CA) is a technology that enables two or more component carriers (CCs, sometimes referred to as carriers) to be combined (e.g., into a single channel) for a single UE 120 to enhance data capacity. Carriers can be combined in the same or different frequency bands. Additionally, or alternatively, contiguous or non-contiguous carriers can be combined. In some examples, a network node may configure CA for a UE, such as in a radio resource control (RRC) message, downlink control information (DCI), and/or another signaling message.

In some cases, the maximum quantity of hybrid automatic repeat request (HARQ) processes that a network node can configure on each cell for a user equipment (UE) is fixed. Increasing the quantity of HARQ processes may prevent delays that can occur in scheduling by the network node, but can also occupy additional memory at the UE. Memory limitations may also prevent the UE from supporting large quantities of CCs and thereby improving peak throughput, even in cases where the UE would otherwise have the capability to support the large quantity of CCs.

Various aspects relate generally to UE capabilities for HARQ. Some aspects more specifically relate to HARQ buffer management for multi-carrier operation. In some aspects, the UE may report a quantity of HARQ processes that is supported by the UE across all configured CCs. In some aspects, the UE may report a HARQ buffering capability of the UE.

In some aspects, the network node may configure a quantity of HARQ processes flexibly across downlink CCs in cases where an overall HARQ buffer budget does not exceed the HARQ buffer capability.

In some aspects, the network node may over-configure the quantity of HARQ processes in cases where aggregated downlink scheduling across all downlink CCs satisfies the total HARQ buffer size of the UE.

In some aspects, the network node may over-configure HARQ processes in cases where downlink scheduling is allowed and pending HARQ retransmissions across all downlink CCs are below the total HARQ buffer size of the UE.

In some aspects, the network node may over-configure the quantity of HARQ processes across downlink CCs along with a per-CC HARQ buffer allocation in cases where physical downlink shared channel (PDSCH) scheduling does not exceed a per-CC HARQ buffer size of the UE.

Particular aspects of the subject matter described in this disclosure can be implemented to realize one or more of the following potential advantages. In some examples, by reporting a quantity of HARQ processes that is supported by the UE across all configured CCs and/or the HARQ buffering capability, the described techniques can be used to increase the quantity of HARQ processes without requiring additional memory at the UE. Additionally, or alternatively, such reporting may help to support a larger number of CCs and/or bandwidth without impacting memory requirements at the UE for HARQ management.

The network node configuring the quantity of HARQ processes flexibly across downlink CCs in cases where an overall HARQ buffer budget does not exceed the HARQ buffer capability may increase control by the UE over HARQ configuration.

The network node over-configuring the quantity of HARQ processes in cases where aggregated downlink scheduling across all downlink CCs satisfies the total HARQ buffer size of the UE may enable use of more HARQ processes.

The network node over-configuring HARQ processes in cases where downlink scheduling is allowed and pending HARQ retransmissions across all downlink CCs are below the total HARQ buffer size of the UE may improve flexibility with respect to scheduling.

The network node over-configuring the quantity of HARQ processes across downlink CCs along with a per-CC HARQ buffer allocation in cases where PDSCH scheduling does not exceed a per-CC HARQ buffer size of the UE may make memory management more static and, thus, less resource-intensive for the UE to implement.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

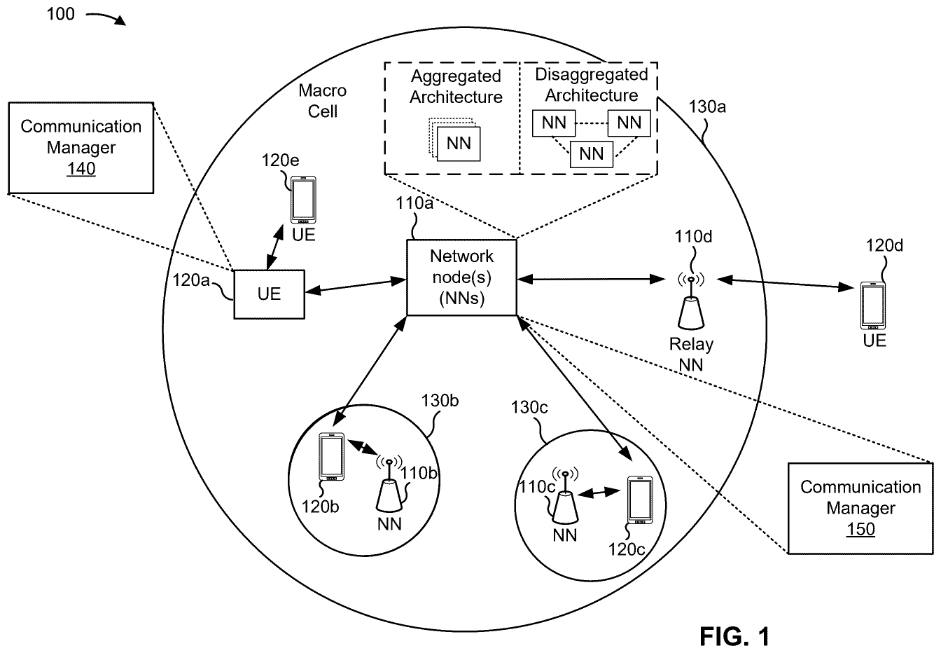

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more PDSCHs. Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs.” An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit a UE capability report indicating a maximum quantity of HARQ processes supported across a plurality of CCs or indicating a HARQ buffering capability; and receive a HARQ process quantity configuration in accordance with the UE capability report. Additionally, or alternatively, the communication manager 140 may perform one or more other operations described herein.

In some aspects, the network node 110 may include a communication manager 150. As described in more detail elsewhere herein, the communication manager 150 may receive a UE capability report indicating a maximum quantity of HARQ processes supported across a plurality of CCs or indicating a HARQ buffering capability; and transmit a HARQ process quantity configuration in accordance with the UE capability report. Additionally, or alternatively, the communication manager 150 may perform one or more other operations described herein.

As indicated above, FIG. 1 is provided as an example. Other examples may differ from what is described with regard to FIG. 1.

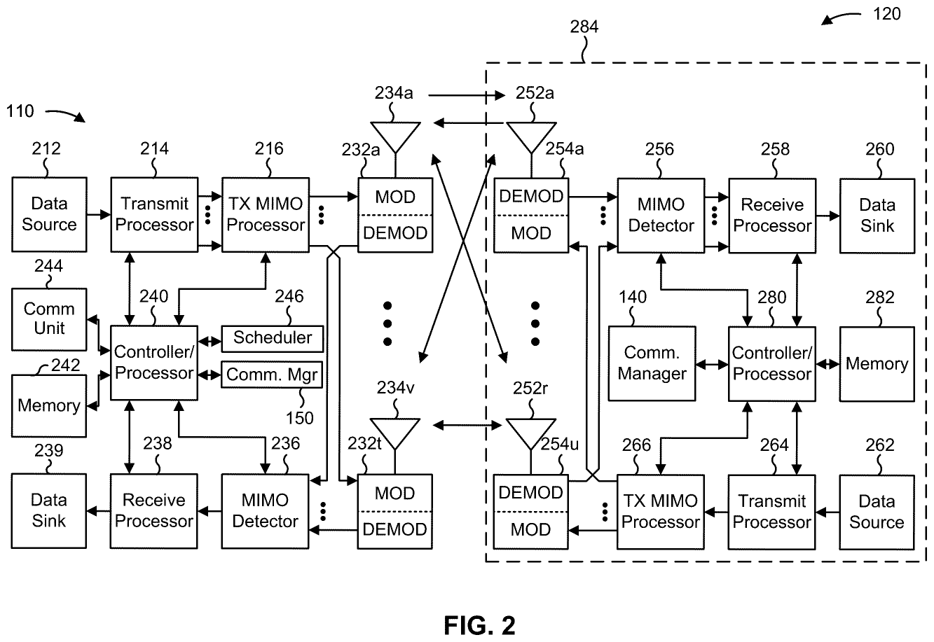

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

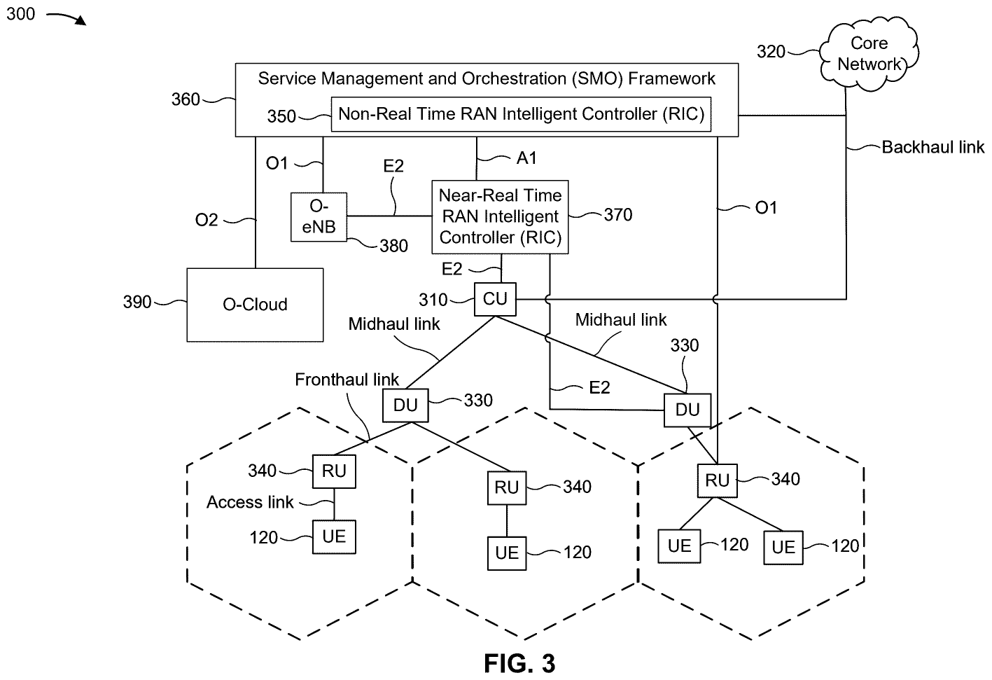

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an 02 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-CNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

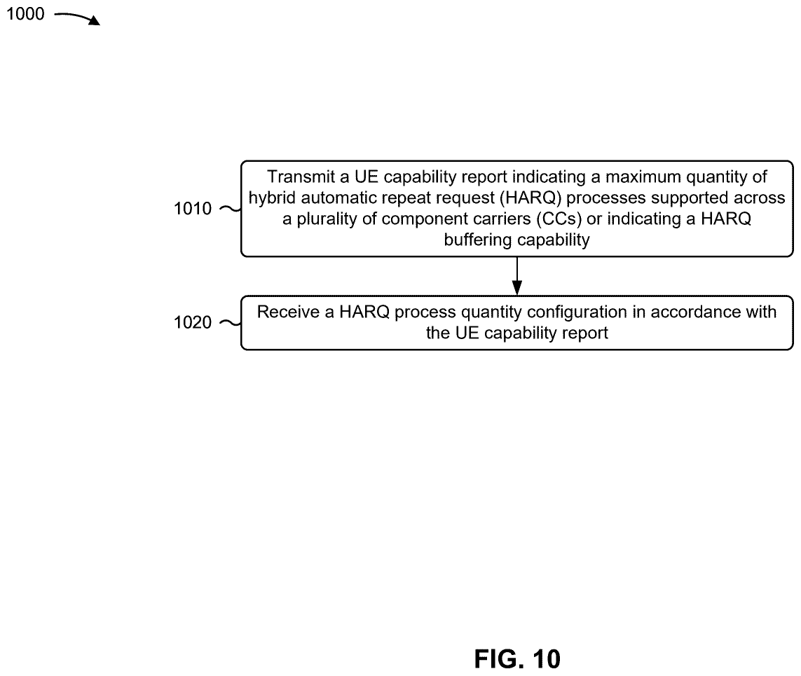

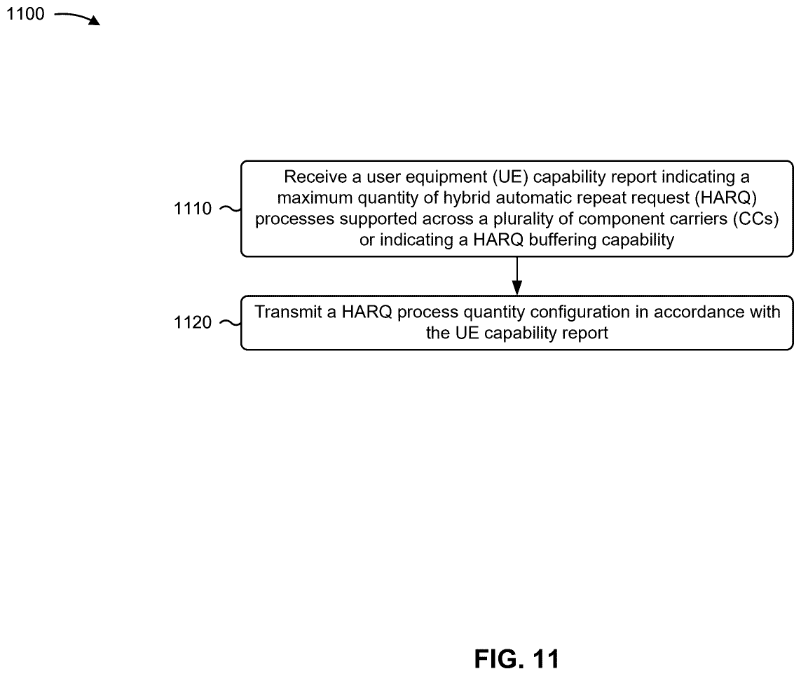

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with UE capabilities for HARQ, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for transmitting a UE capability report indicating a maximum quantity of HARQ processes supported across a plurality of CCs or indicating a HARQ buffering capability; and/or means for receiving a HARQ process quantity configuration in accordance with the UE capability report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a UE capability report indicating a maximum quantity of HARQ processes supported across a plurality of CCs or indicating a HARQ buffering capability; and/or means for transmitting a HARQ process quantity configuration in accordance with the UE capability report. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

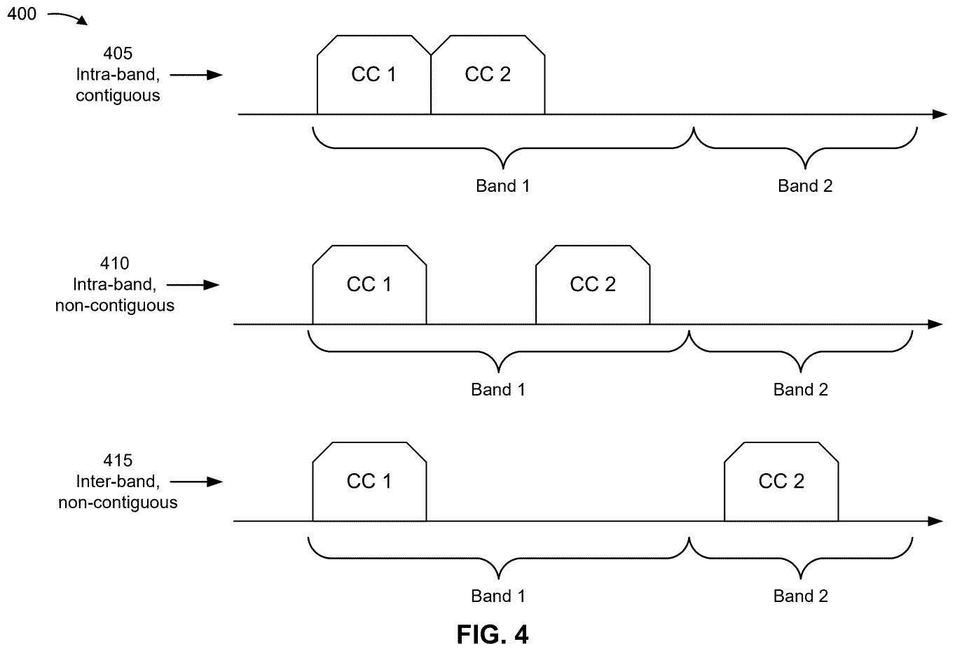

FIG. 4 is a diagram illustrating examples 400 of carrier aggregation, in accordance with the present disclosure.

As shown by reference number 405, in some aspects, CA may be configured in an intra-band contiguous mode where the aggregated carriers are contiguous to one another and are in the same band. As shown by reference number 410, in some aspects, CA may be configured in an intra-band non-contiguous mode where the aggregated carriers are non-contiguous to one another and are in the same band. As shown by reference number 415, in some aspects, CA may be configured in an inter-band non-contiguous mode where the aggregated carriers are non-contiguous to one another and are in different bands.

In CA, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 4 is provided as an example. Other examples may differ from what is described with regard to FIG. 4.

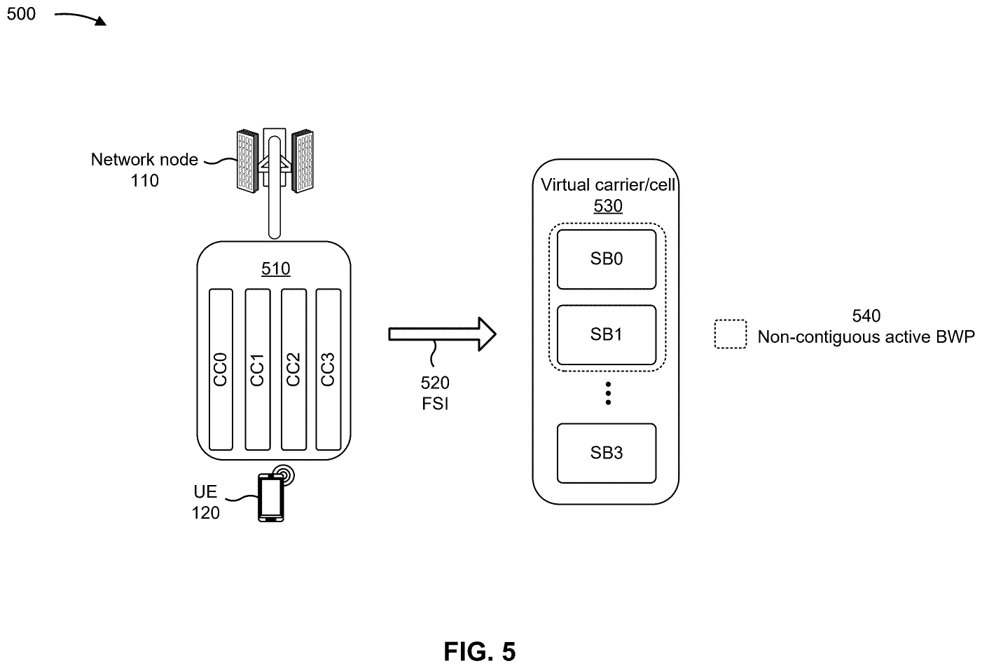

FIG. 5 is a diagram illustrating an example 500 of flexible spectrum integration (FSI), in accordance with the present disclosure.

As shown by reference number 510, a network node 110 (e.g., an RU and/or a DU) and a UE 120 may communicate with each other over multiple CCs, such as CC0-CC3 (e.g., using CA). In some examples, FSI may unify PHY and/or MAC layers across CC0-CC3. For example, as shown by reference number 520, FSI may enable integration of CC0-CC3 (in the same or different bands) to form a virtual carrier or virtual cell 530. For example, the virtual carrier or virtual cell 530 may include sub-bands (SBs), such as SB0-SB3, where a SB is one physical carrier or a portion of a physical carrier. As shown, SB0 and SB1 comprise a non-contiguous active BWP 540.

The virtual carrier or virtual cell 530 may function as a single scheduling and HARQ entity. For example, the virtual carrier or virtual cell 530 may serve as a single cell for purposes of scheduling and HARQ. As a result, FSI may use an equivalent of one CC of a PDCCH for scheduling, smaller decoding attempts and narrower RF for PDCCH, unified retransmissions across SBs for improved diversity, or the like.

In some examples, FSI may enable different flavors of TB scheduling across aggregated SBs. For example, FSI may integrate small and scattered FDD channels into a single virtual carrier (e.g., the virtual carrier or virtual cell 530) with single-TB scheduling. Additionally, or alternatively, FSI may enable multi-TB scheduling with a single-CC PDCCH for large, aggregated bandwidth.

In some examples, FSI may enable bandwidth adaptation using a BWP mechanism. For example, FSI may enable low-latency adaptation depending on the RF bandwidth of the UE and/or configured measurements.

As indicated above, FIG. 5 is provided as an example. Other examples may differ from what is described with regard to FIG. 5.

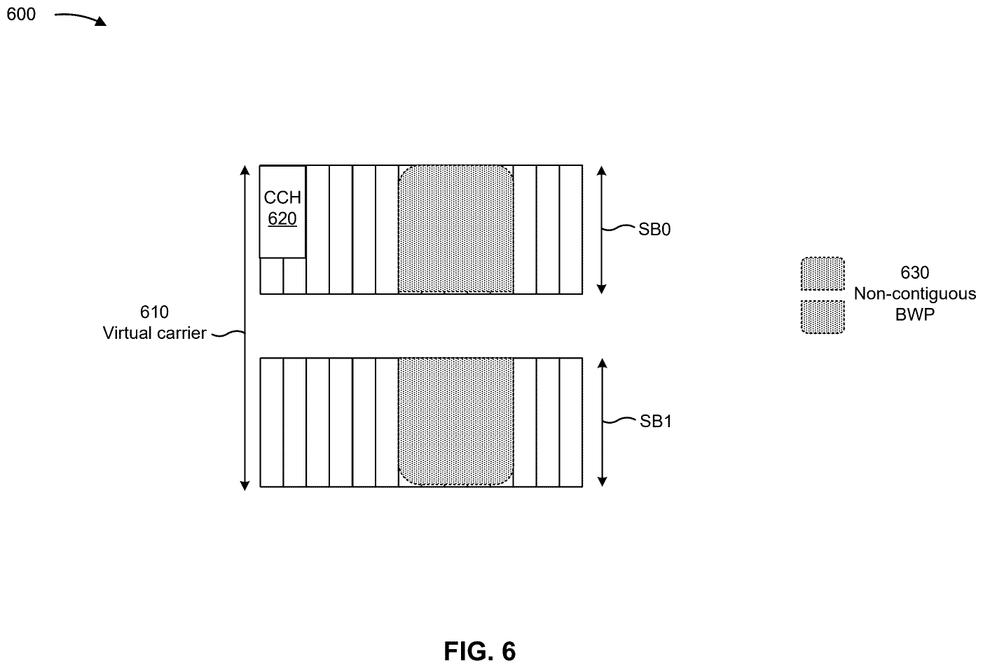

FIG. 6 is a diagram illustrating an example 600 of FSI with single-physical-shared-channel TB scheduling and mapping, in accordance with the present disclosure.

Example 600 shows a virtual carrier 610 that includes two SBs, SB0 and SB1. SB0 may serve as an anchor that contains one or more PDCCH candidates (“CCH”) 620. For example, the UE 120 may perform single-CC PDCCH blind detection on SB0 and identify a single DCI communication carried in the PDCCH.

In some examples, SB0 and SB1 may have respective TBs that comprise a single PxSCH communication (e.g., a single PDSCH communication, a single PUSCH communication, or the like) scheduled by the single DCI communication. For example, the TBs may be mapped onto a non-contiguous BWP 630 that is activated within a virtual cell.

In some examples, FSI may enable TB mapping across SB0 and SB1 with code-block-level interleaving, which may be favorable in a low-band spectrum with small channels. Additionally, or alternatively, a TB spanning different SBs may be scheduled with different link parameters, such as modulation order, rank, or the like. In some examples, FSI may involve integrating bands with the same sub-carrier spacing and co-located deployment.

As indicated above, FIG. 6 is provided as an example. Other examples may differ from what is described with regard to FIG. 6.

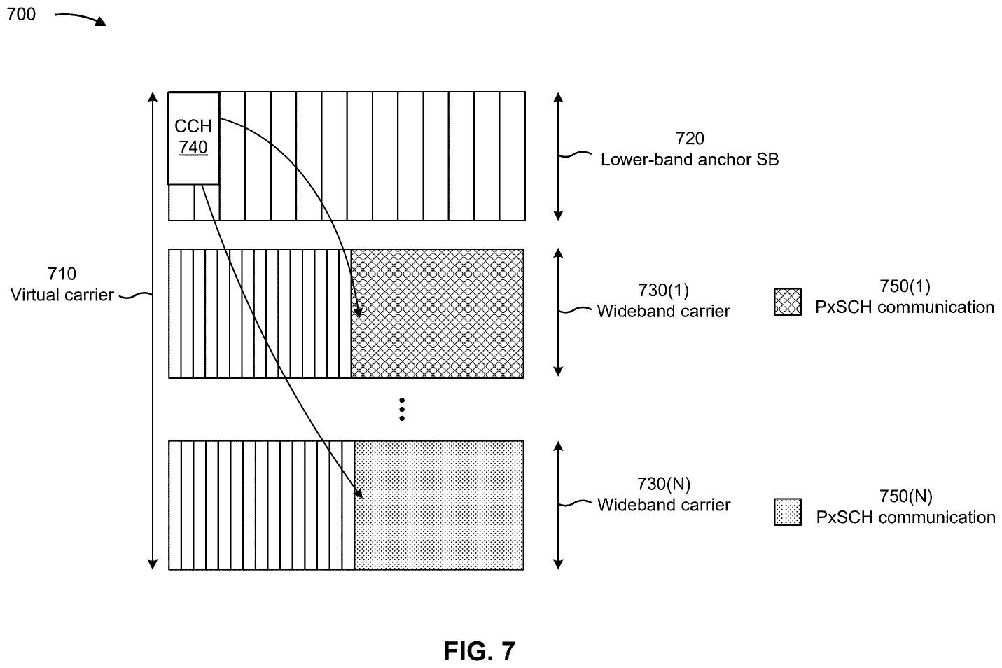

FIG. 7 is a diagram illustrating an example 700 of FSI with multi-SB scheduling DCI (mSB DCI), in accordance with the present disclosure.

Example 700 shows a virtual carrier 710 (e.g., a virtual cell) that includes a lower-band anchor SB 720 and a plurality of wideband carriers 730(1)-730(N) in higher frequency ranges. SB0 may include one or more PDCCH candidates (“CCH”) 740. For example, the UE 120 may perform single-CC PDCCH blind detection on the one or more PDCCH candidates 740 for scheduling multiple TBs on different SBs and identify an mSB DCI communication carried in the PDCCH.

Each TB may be mapped to a single SB of the virtual carrier 710. For example, the TBs may comprise PxSCH communications 750(1)-750(N) scheduled by mSB DCI in respective wideband carriers 730(1)-730(N). This process may resemble multi-cell DCI (MC-DCI) scheduling, but the UE 120 may not need to support self-carrier scheduling.

Example 700 may be suitable for scheduling with large, aggregated channel bandwidths (e.g., in cases where cross-SB diversity is not needed). In some examples, both intra-band and inter-band scenarios may be supported. Because the virtual carrier 710 is a single HARQ entity, frequency diversity across HARQ transmissions may be achieved.

As indicated above, FIG. 7 is provided as an example. Other examples may differ from what is described with regard to FIG. 7.

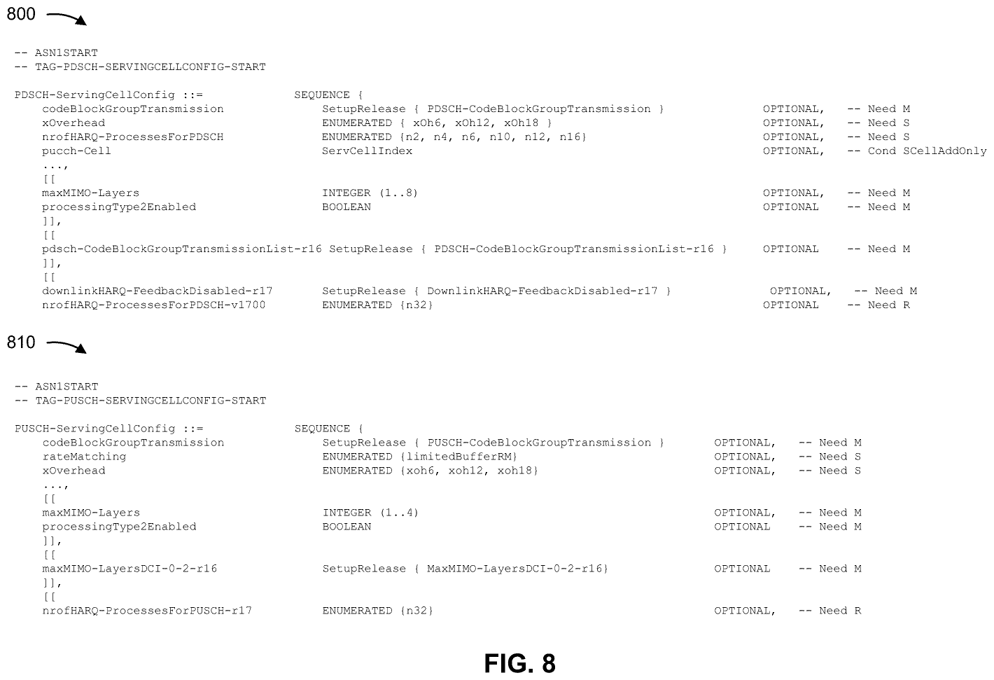

FIG. 8 is a diagram illustrating examples 800 and 810 of HARQ process quantity configuration, in accordance with the present disclosure.

A quantity of HARQ processes may be configured separately for downlink communications and uplink communications. Example 800 relates to configuration of a quantity of HARQ processes for downlink communications, and example 810 relates to configuration of a quantity of HARQ processes for uplink communications.

Example 800 shows a PDSCH-ServingCellConfig information element (IE) that is used to configure UE-specific PDSCH parameters that are common across BWPs of one serving cell for the UE 120. One such UE-specific PDSCH parameter is nrofHARQ-ProcessesforPDSCH, which controls the quantity of HARQ processes to be used on the PDSCH of a serving cell. A value of n2 corresponds to 2 HARQ processes, a value of n4 corresponds to 4 HARQ processes, and so on. If both nrofHARQ-ProcessesforPDSCH and nrofHARQ-ProcessesforPDSCH-v1700 are absent, then the UE 120 may use 8 HARQ processes.

Example 810 shows a PUSCH-ServingCellConfig IE that is used to configure UE-specific PUSCH parameters that are common across BWPs of one serving cell for the UE 120. One such UE-specific PUSCH parameter is nrofHARQ-ProcessesforPUSCH, which controls the quantity of HARQ processes to be used on the PUSCH of a serving cell. A value of n32 corresponds to 32 HARQ processes. If nrofHARQ-ProcessesforPDSCH is absent, then the UE 120 may use 16 HARQ processes.

In some cases, the maximum quantity of HARQ processes that can be configured on each cell is fixed. The network node 110 may configure a smaller quantity of HARQ processes than the maximum quantity of HARQ processes. A UE may not directly (e.g., explicitly) signal a UE capability for the quantity of HARQ processes; rather, the quantity of HARQ processes may be implicitly tied to the quantity of CCs that the UE can support For example, if the UE reports a capability for supporting Y CCs in downlink or uplink, then the UE may also be able to support Y multiplied by the maximum quantity of downlink HARQ processes or Y multiplied by the maximum quantity of uplink HARQ processes.

However, increasing the quantity of HARQ processes may be helpful in some scenarios, such as scenarios involving a CA configuration where a processing or turnaround time is faster on one group of CCs than another group of CCs. For example, in a CA configuration with CCs configured in FR1 and CCs configured in FR2 with the Pcell on FR1, a scheduler (e.g., network node 110) may schedule a set of PDSCH communications on the CCs configured in FR2. In some cases, the set of PDSCH communications may consume all the HARQ processes, and the scheduler may be unable to schedule any more PDSCH communications until the network node 110 receives a HARQ-ACK report. Because turnaround times may be faster in FR2 than FR1, delays (e.g., gaps) may occur in scheduling on the CCs configured in FR2, which may lead to throughput degradation.

Increasing a quantity of HARQ processes may reduce scheduling delays in such scenarios but can also occupy additional memory at the UE 120. For example, the UE 120 may require sufficient memory to maintain a context for each HARQ process (e.g., a HARQ identifier, a TB size, a redundancy value (RV) index, a new data indicator (NDI), MCS, or the like), maintain log-likelihood ratios (LLRs) (e.g., as SUM_cc (#HARQ buffer,c*#Layers,c*max mod order,c*max #RBs,c), where SUM_cc is operation that sums over CCs, #HARQ buffer,c refers to a quantity of HARQ buffers configured on a CC, #Layers,c refers to a maximum quantity of MIMO layers that can be configured on the CC, max mod order,c refers to a maximum modulation order configured on the CC, and max #RBs,c refers to a maximum quantity of resource blocks (RBs) configured on the CC), or the like.

Large quantities of CCs and/or bandwidth can also impact memory requirements for HARQ management. For example, a UE may have sufficient memory to support three downlink CCs with certain bandwidth (e.g., in band 1 (B1)), a maximum quantity of MIMO layers, and a maximum modulation order. However, to perform multi-carrier operation in B1 and band 2 (B2), the UE may need additional memory. Because the UE does not have such additional memory, the UE may instead report a smaller quantity of CCs in B1. For example, the UE may report two CCs in B1 and one CC in B2.

In some cases, the UE may report the smaller quantity of CCs in cases where bottlenecking is caused by bookkeeping the HARQ process context. If bottlenecking is caused by buffering LLRs, then reducing the quantity of reported CCs, the quantity of layers (e.g., MIMO layers), the modulation order, and/or the bandwidth may help also or alternatively help to increase the quantity of CCs.

Because CC and/or bandwidth scaling and HARQ process scaling are dependent (e.g., correlated), the UE may be unable to support larger quantities of CCs and therefore improve peak throughput even in cases where the UE has the RF and modem (e.g., baseband) capability to support the larger quantity of CCs.

As indicated above, FIG. 8 is provided as an example. Other examples may differ from what is described with regard to FIG. 8

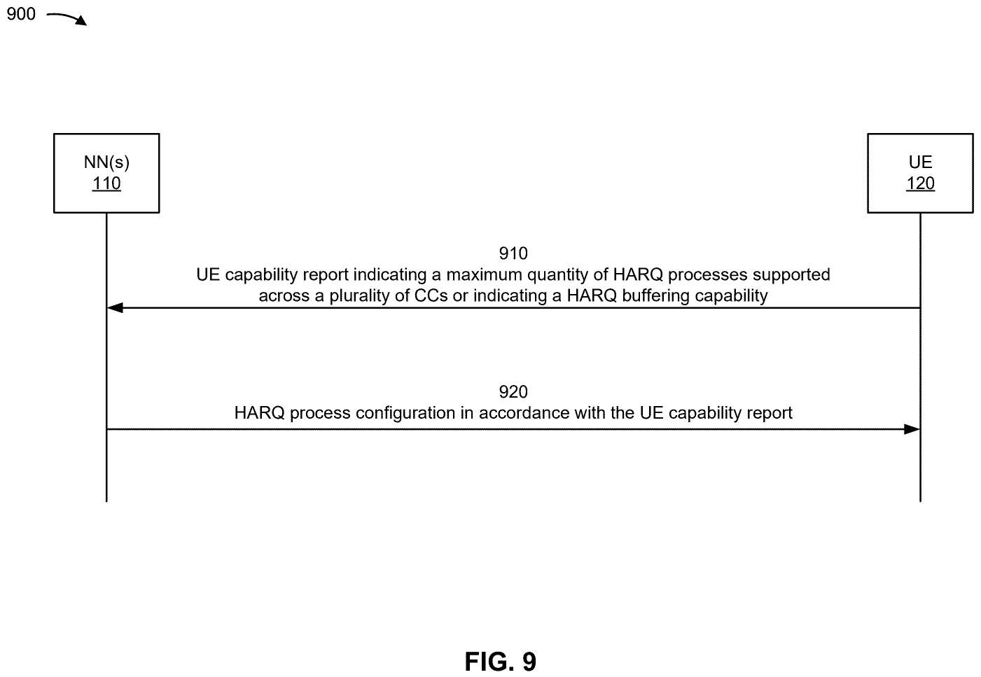

FIG. 9 is a diagram illustrating an example 900 associated with UE capabilities for HARQ, in accordance with the present disclosure. As shown in FIG. 9, a network node 110 and a UE 120 may communicate with one another. In some examples, the network node 110 and a UE 120 may communicate using CA, as described above in connection with FIG. 4. In some examples, the network node 110 and a UE 120 may communicate using FSI, as described above in connection with FIGS. 5-7.

As shown by reference number 910, the UE 120 may transmit, and the network node 110 may receive, a UE capability report. In some aspects, the UE capability report may indicate a maximum quantity of HARQ processes supported across a plurality of CCs. For example, the UE 120 may report the maximum quantity of HARQ processes that the UE 120 can support across all configured CCs. The UE 120 may report the maximum quantity of HARQ processes as a capability. In scenarios involving FSI, the plurality of CCs may comprise one or more SBs.

In some examples, the maximum quantity of HARQ processes may be indicated on a per-UE basis, a per-band basis, a per-band-combination basis, a per-feature-set basis, a per-feature-set-per-carrier basis, or the like. In some examples, a total maximum quantity of HARQ processes may be reported separately for different frequency ranges (e.g., the total maximum quantity of HARQ processes may be a separate constraint for each frequency range.)

The maximum quantity of HARQ processes may be the same or separate (e.g., different) for downlink and uplink. For example, depending on UE implementation and/or memory management, the maximum quantity of HARQ processes for downlink and uplink may be shareable. For example, configuring a smaller quantity of HARQ processes in one of downlink or uplink may involve configuring a larger maximum quantity of HARQ processes in the other of downlink or uplink. The translation between the maximum quantity of HARQ processes in one of downlink or uplink and the maximum quantity of HARQ processes in the other of downlink or uplink may be one-to-one or involve a weighting factor.

Additionally, or alternatively, the maximum quantity of HARQ processes may be based at least in part on processing timelines. For example, different quantities of HARQ processes may be reported depending on whether a first processing capability (e.g., associated with a slow timeline) or a second processing capability (e.g., associated with a fast timeline) is configured.

In some aspects, the UE capability report may indicate a HARQ buffering capability. For example, the HARQ buffering capability may be a capability of the UE 120 that is based at least in part on a quantity of CCs supported by the UE 120, a quantity of layers (e.g., MIMO layers) supported by the UE 120, a maximum modulation order supported by the UE 120, a quantity of RBs (or bandwidth) supported by the UE 120, or the like. In some examples, the HARQ buffering capability may be a HARQ buffering limit. In some examples, the HARQ buffering capability may be reported on a per-UE basis, a per-band basis, a per-frequency-range basis, a per-band-combination basis, a per-feature-set basis, or the like.

In some examples, the HARQ buffering capability may be a total HARQ buffering capability that is equal to Σ_{c} #HARQ processes, c*#Layers, c*max mod order, c*#RBs, c, where #HARQ processes, c refers to a quantity of HARQ processes configured on a CC, and #RBs, c refers to a quantity of RBs configured on a CC. In such examples, #Layers, c, max mod order, c, and/or #RBs, c may be the maximum values configured on a CC. For example #RBs, c may refer to a total quantity of RBs per BWP or in the CC. For cases involving FSI with a single HARQ entity across all integrated SBs, this limit may be defined as total #HARQ processes*Σ #Layers, SBᵢ*max. mod order, SBᵢ*#RBs,SBᵢ, where total #HARQ processes refers to a total quantity of HARQ processes, #Layers, SBᵢ refers to a quantity of MIMO layers configured on an SB, max. mod order, SBᵢ refers to a maximum modulation order configured on the SB, and #RBs, SBᵢ refers to a quantity of RBs configured on an SB. In such examples, #Layers, SBᵢ, max mod order, SBᵢ, and/or #RBs, SBᵢ may be the maximum values configured on a CC. For example, #RBs, SBᵢ may refer to a total quantity of RBs in the SB, a quantity of RBs in a BWP configured in the SB (e.g., in cases where there is a separate BWP per SB), or a quantity of RBs within the BWP in the SB (e.g., in cases where a wide-band BWP covers multiple SBs, possibly including a portion (but not all) of one of the SBs). Calculation of the HARQ buffering capability, by the UE 120, may account for configured CCs or only active CCs (e.g., in cases where some CCs are deactivated or set in dormant states, those deactivated or dormant CCs may not be accounted for in the calculation.)

In some aspects, the UE capability report may further indicate a maximum quantity of HARQ processes supported on a serving cell of the UE 120. For example, the UE capability report may further indicate the maximum quantity of HARQ processes that the UE 120 can support on each serving cell. In some examples, the maximum quantity of HARQ processes supported on a serving cell of the UE 120 may be indicated on a per-UE basis, a per-band basis, a per-frequency-range basis, a per-band-combination basis, or the like.

As shown by reference number 920, the network node 110 may transmit, and the UE 120 may receive, a HARQ process quantity configuration in accordance with the UE capability report. The HARQ process quantity configuration may be in accordance with the UE capability report in that the HARQ process quantity configuration may configure a quantity of HARQ processes based at least in part on the UE capability report. The HARQ process quantity configuration may include one or more parameters shown in FIG. 8 and/or one or more parameters associated with the UE capability report. As discussed in greater detail below, the HARQ process quantity configuration may configure the quantity of HARQ processes based at least in part on the maximum quantity of HARQ processes and/or the HARQ buffering capability indicated in the UE capability report.

In some aspects, the HARQ process quantity configuration may configure one or more HARQ processes on a set of CCs. In cases where a quantity of CCs of the set of CCs does not satisfy (e.g., does not exceed) a CC quantity threshold α, the UE 120 may support a per-CC maximum quantity of HARQ processes X on each CC of the quantity of CCs (e.g., X may be a maximum quantity of HARQ processes that the UE 120 can support on a CC). For example, in cases where the UE 120 is configured with fewer than a CCs, the UE 120 may increase the quantity of HARQ processes linearly (e.g., by multiplying X by the number of CCs configured for the UE 120). For example, if α=4 CCs and X=16 HARQ processes, and if the UE 120 is configured with one CC, then the UE 120 may support 16 HARQ process; if UE 120 is configured with two CCs, then the UE 120 may be able to support 32 HARQ process; and so forth.

In cases where the quantity of CCs of the set of CCs satisfies (e.g., exceeds) α, the UE 120 may support, on each CC of the set of CCs, fewer HARQ processes than X. For example, if the quantity of CCs is greater than a, then α×X HARQ processes should be split by the gNB across the configured CCs. Thus, a minimum of the total quantity of HARQ processes (e.g., α×X) may be enforced. For example, if α=4 CCs and X=16 HARQ processes, and if the UE 120 is configured with five CCs, then the UE 120 may share 64 HARQ processes across the five CCs.

Thus, α may be interpreted as a quantity of CCs below which the UE 120 increases the quantity of HARQ process linearly and above which the UE 120 does not necessarily increase the quantity of HARQ process linearly. α may be any suitable number, and may be reported by the UE 120 or defined in a wireless communication standard. In some examples, the wireless communication standard may enforce a minimum number for α, and the UE 120 may support a larger number for α and may report the larger number as a UE capability.

Aspects provided below relate to configuration of HARQ processes across CCs, and such aspects may be implemented alone or in combination with one or more other such aspects. One or more such aspects may be signaled based at least in part on one or more UE capabilities (e.g., in cases where such aspects are combined with each other).

In some aspects, the HARQ process quantity configuration may be in accordance with the HARQ buffering capability. For example, the UE capability report may indicate the HARQ buffering capability (e.g., and not indicate the maximum quantity of HARQ processes supported across the plurality of CCs). In some examples, the maximum quantity of configurable HARQ processes per serving cell may be fixed (e.g., defined in a wireless communication standard), the total quantity of HARQ processes may be equal to the quantity of CCs multiplied by the quantity of HARQ processes per CC, and the network node 110 may configure the quantity of HARQ processes flexibly across downlink CCs provided an overall HARQ buffer budget does not exceed the HARQ buffer capability of the UE 120. For example, the quantity of HARQ processes configured per CC may not have a fixed limit as long as the HARQ buffering capability (e.g., the total HARQ buffering limit) is satisfied.

For example, in some scenarios, the UE 120 may be configured with downlink CA below a CA envelope capability of the UE 120. If the UE 120 is equipped with RF and/or modem capability to support 3 downlink CCs in FR1 and 8 downlink CCs in FR2 but is configured with 2 downlink CCs in FR1 and 8 downlink CCs in FR2, then the UE 120 may support additional HARQ processes on the FR2 CCs. The distribution of the additional HARQ processes on the FR2 downlink CCs may be flexible or may be limited to an extra M HARQ processes per FR2 CCs.

In some aspects, the HARQ process quantity configuration may be in accordance with the HARQ buffering capability and may configure a quantity of HARQ processes that exceeds the maximum quantity of HARQ processes. For example, the UE capability report may indicate the HARQ buffering capability (e.g., the total HARQ buffer limit), and the network node 110 may over-configure the total quantity of HARQ processes relative to the maximum quantity of HARQ processes supported across the plurality of CCs. The total quantity of HARQ processes may be over-configured in that the total quantity of HARQ processes configured for the UE 120 may be larger than the reported value for the maximum quantity of HARQ processes. For example, in cases where the maximum quantity of HARQ processes (e.g., a total quantity of HARQ processes) is reported by the UE 120 (and not necessarily scaled by the number of CCS that the UE 120 supports), the network node 110 may over-configure the quantity of HARQ processes supported across the plurality of CCs.

In some aspects (e.g., where the HARQ process quantity configuration is in accordance with the HARQ buffering capability and configures a quantity of HARQ processes that exceeds the maximum quantity of HARQ processes), downlink scheduling aggregated across downlink CCs may satisfy the HARQ buffering capability. For example, the network node 110 may over-configure the quantity of HARQ processes, but aggregated downlink scheduling across all downlink CCs may nonetheless satisfy the HARQ buffering capability (e.g., the total HARQ buffer size) of the UE 120.

In some examples where downlink scheduling aggregated across downlink CCs satisfies the HARQ buffering capability, a time window with length T slots may be defined such that for scheduling in slot n, the scheduler may ensure that the HARQ buffering capability (e.g., the HARQ buffer limit across CCs) is complied with over the entire set of T slots before and including slot n. The length T may depend on the maximum quantity of HARQ processes reported by the UE 120 as a capability and/or on the quantity of over-configured HARQ processes. In cases where the HARQ buffering capability is not complied with, the UE 120 may drop LLRs for certain HARQ processes. The HARQ processes for which the LLRs are dropped may be selected by the UE 120 or based at least in part on one or more rules (e.g., rules that use HARQ process identifiers and/or time of scheduling (e.g., a rule may specify that a later-scheduled TB is dropped first or last)).

In some aspects, (e.g., where the HARQ process quantity configuration is in accordance with the HARQ buffering capability and configures a quantity of HARQ processes that exceeds the maximum quantity of HARQ processes), pending HARQ retransmissions across downlink CCs may satisfy the HARQ buffering capability. A pending HARQ retransmission may be associated with a HARQ process for which an LLR is to be stored. For example, the network node 110 may over-configure HARQ processes, but downlink scheduling may be allowed as long as the pending HARQ retransmissions across all downlink CCs satisfy the HARQ buffering capability (e.g., is below the total HARQ buffer size). The counting of the pending HARQ retransmissions may not necessarily depend on HARQ feedback; in some cases, the counting of the pending HARQ retransmissions may be probabilistic (e.g., the network node 110 may schedule to ensure the quantity of pending HARQ retransmissions is not larger than that afforded by the UE capability). In cases where the quantity of pending HARQ retransmissions is larger than that afforded by the UE capability, the UE 120 may drop LLRs for certain HARQ processes. The HARQ processes for which the LLRs are dropped may be selected by the UE 120 or based at least in part on one or more rules (e.g., rules that use HARQ process identifiers).

In some aspects, the HARQ buffering capability may include one or more of a maximum per-CC HARQ buffer size or a maximum aggregate HARQ buffer size across the plurality of CCs. In some examples, the HARQ buffering capability may include the maximum per-CC HARQ buffer size (e.g., and not the maximum aggregate HARQ buffer size). In some examples, the HARQ buffering capability may include both the maximum per-CC HARQ buffer size and the maximum aggregate HARQ buffer size. In some examples, the maximum per-CC HARQ buffer size (e.g., a per-CC HARQ buffer limit) may be defined as #HARQ processes, c*#Layers, c*max. mod order, c*#RBs, c. In some aspects, the HARQ process quantity configuration may configure a quantity of HARQ processes that exceeds the maximum quantity of HARQ processes across downlink CCs and satisfies the maximum per-CC HARQ buffer size or the maximum aggregate HARQ buffer size. For example, the network node 110 may over-configure the quantity of HARQ processes across the downlink CCs along with a per-CC HARQ buffer allocation as long as PDSCH scheduling does not exceed the per-CC HARQ buffer size of the UE 120.

In some aspects (e.g., where the HARQ buffering capability includes one or more of a maximum per-CC HARQ buffer size or a maximum aggregate HARQ buffer size across the plurality of CCs, and the HARQ process quantity configuration configures a quantity of HARQ processes that exceeds the maximum quantity of HARQ processes across downlink CCs and satisfies the maximum per-CC HARQ buffer size or the maximum aggregate HARQ buffer size), the HARQ process quantity configuration may configure, for a downlink CC, a quantity of HARQ processes that exceeds a per-CC maximum quantity of HARQ processes or an aggregate maximum quantity of HARQ processes across the plurality of CCs, and downlink scheduling aggregated across downlink CCs may satisfy the maximum per-CC HARQ buffer size. For example, the network node 110 may over-configure HARQ processes in a downlink CC, but aggregated downlink scheduling may be limited to a per-CC HARQ buffer size. Examples described above with respect to the time window with length T slots may be applied to these aspects with the HARQ buffering capability (e.g., the HARQ buffering requirement) being per-CC (e.g., rather than cross-CC). In some examples, the HARQ buffering capability may include the maximum per-CC HARQ buffer size (e.g., and not the maximum aggregate HARQ buffer size).

In some aspects (e.g., where the HARQ buffering capability includes one or more of a maximum per-CC HARQ buffer size or a maximum aggregate HARQ buffer size across the plurality of CCs, and the HARQ process quantity configuration configures a quantity of HARQ processes that exceeds the maximum quantity of HARQ processes across downlink CCs and satisfies the maximum per-CC HARQ buffer size or the maximum aggregate HARQ buffer size), the HARQ process quantity configuration may configure, for a downlink CC, a quantity of HARQ processes that exceeds a per-CC maximum quantity of HARQ processes or an aggregate maximum quantity of HARQ processes across the plurality of CCs, and pending HARQ retransmissions for the downlink CC may satisfy the maximum per-CC HARQ buffer size. For example, the network node 110 may over-configure HARQ processes in a downlink CC, but downlink scheduling may be allowed as long as the pending HARQ retransmissions satisfies the HARQ buffering capability (e.g., is below the HARQ buffer size for the CC). In cases where the quantity of pending HARQ retransmissions is larger than that afforded by the UE capability, the UE 120 may drop LLRs for certain HARQ processes. The HARQ processes for which the LLRs are dropped may be selected by the UE 120 or based at least in part on one or more rules (e.g., rules that use HARQ process identifiers). In some examples, the HARQ buffering capability may include the maximum per-CC HARQ buffer size (e.g., and not the maximum aggregate HARQ buffer size).

The UE capability report indicating a maximum quantity of HARQ processes supported across a plurality of CCs or indicating a HARQ buffering capability may help to increase the quantity of HARQ processes without requiring additional memory at the UE 120. Additionally, or alternatively, the UE capability report may help to support a larger number of CCs and/or bandwidth without impacting memory requirements at the UE 120 for HARQ management.

The HARQ process quantity configuration being in accordance with the HARQ buffering capability may increase control by the UE 120 over the HARQ process quantity configuration.

The downlink scheduling aggregated across downlink CCs satisfying the HARQ buffering capability may (e.g., once calculation of total buffer size and a relationship of the total buffer size to the quantity of layers, modulation order, and/or RBs is defined) enable use of more HARQ processes (e.g., provided the maximum quantity of HARQ processes (e.g., the total limit) is respected during scheduling).

The pending HARQ retransmissions across downlink CCs satisfying the HARQ buffering capability may improve flexibility with respect to scheduling. Flexibility may be improved because only HARQ processes that are pending may be accounted for. For example, to support a first CC (C0) and a second CC (C1) for CA, the UE 120 may support 16 HARQ processes for each CC. If the UE 120 reports a smaller quantity of HARQ processes than 16 (e.g., 8), and the network node 110 is permitted to over-configure the quantity of HARQ process (e.g., by configuring 32 HARQ processes in total), then the network node 110 may configure 16 HARQ processes per serving cell. In some examples, the network node 110 may perform scheduling such that no more than 8 HARQ processes are pending simultaneously. By contrast, if over-configuration is not permitted, then the network node may configure four HARQ process in each. Thus, over-configuration may flexibly use scheduling to increase the quantity of HARQ processes with requiring additional memory at the UE 120.

The HARQ buffering capability including one or more of a maximum per-CC HARQ buffer size or a maximum aggregate HARQ buffer size across the plurality of CCs, and the HARQ process quantity configuration configuring a quantity of HARQ processes that exceeds the maximum quantity of HARQ processes across downlink CCs and satisfies the maximum per-CC HARQ buffer size or the maximum aggregate HARQ buffer size, may make memory management more static and, thus, less resource-intensive for the UE 120 to implement.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with UE capabilities for HARQ.

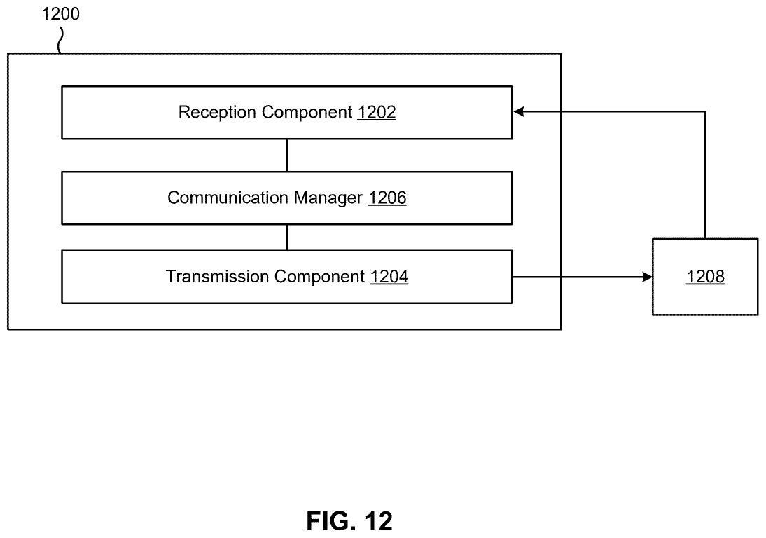

As shown in FIG. 10, in some aspects, process 1000 may include transmitting a UE capability report indicating a maximum quantity of HARQ processes supported across a plurality of CCs or indicating a HARQ buffering capability (block 1010). For example, the UE (e.g., using transmission component 1204 and/or communication manager 1206, depicted in FIG. 12) may transmit a UE capability report indicating a maximum quantity of HARQ processes supported across a plurality of CCs or indicating a HARQ buffering capability, as described above.

As further shown in FIG. 10, in some aspects, process 1000 may include receiving a HARQ process quantity configuration in accordance with the UE capability report (block 1020). For example, the UE (e.g., using reception component 1202 and/or communication manager 1206, depicted in FIG. 12) may receive a HARQ process quantity configuration in accordance with the UE capability report, as described above.

Process 1000 may include additional aspects, such as any single aspect or any combination of aspects described below and/or in connection with one or more other processes described elsewhere herein.

In a first aspect, the HARQ process quantity configuration configures one or more HARQ processes on a set of CCs, and a quantity of CCs of the set of CCs does not satisfy a CC quantity threshold, and the UE supports a per-CC maximum quantity of HARQ processes on each CC of the set of CCs, or the quantity of CCs satisfies the CC quantity threshold, and the UE supports, on each CC of the set of CCs, fewer HARQ processes than the per-CC maximum quantity of HARQ processes.

In a second aspect, alone or in combination with the first aspect, the UE capability report further indicates a maximum quantity of HARQ processes supported on a serving cell of the UE.

In a third aspect, alone or in combination with one or more of the first and second aspects, the HARQ process quantity configuration is in accordance with the HARQ buffering capability.

In a fourth aspect, alone or in combination with one or more of the first through third aspects, the HARQ process quantity configuration is in accordance with the HARQ buffering capability and configures a quantity of HARQ processes that exceeds the maximum quantity of HARQ processes.

In a fifth aspect, alone or in combination with one or more of the first through fourth aspects, downlinking scheduling aggregated across downlink CCs satisfies the HARQ buffering capability.

In a sixth aspect, alone or in combination with one or more of the first through buffering capability.

In a seventh aspect, alone or in combination with one or more of the first through sixth aspects, the HARQ buffering capability includes one or more of a maximum per-CC HARQ buffer size or a maximum aggregate HARQ buffer size across the plurality of CCs, and the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

In an eighth aspect, alone or in combination with one or more of the first through seventh aspects, the HARQ process quantity configuration configures, for a downlink CC, a quantity of HARQ processes that exceeds a per-CC maximum quantity of HARQ processes or an aggregate maximum quantity of HARQ processes across the plurality of CCs, and downlink scheduling aggregated across downlink CCs satisfies the maximum per-CC HARQ buffer size.

In a ninth aspect, alone or in combination with one or more of the first through eighth aspects, the HARQ process quantity configuration configures, for a downlink CC, a quantity of HARQ processes that exceeds a per-CC maximum quantity of HARQ processes or an aggregate maximum quantity of HARQ processes across the plurality of CCs, and pending HARQ retransmissions for the downlink CC satisfy the maximum per-CC HARQ buffer size.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with UE capabilities for HARQ.

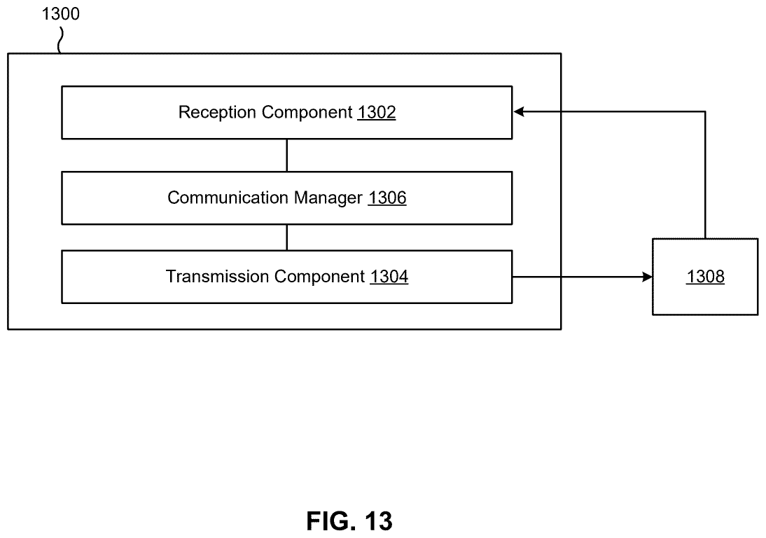

As shown in FIG. 11, in some aspects, process 1100 may include receiving a UE capability report indicating a maximum quantity of HARQ processes supported across a plurality of CCs or indicating a HARQ buffering capability (block 1110). For example, the network node (e.g., using reception component 1302 and/or communication manager 1306, depicted in FIG. 13) may receive a UE capability report indicating a maximum quantity of HARQ processes supported across a plurality of CCs or indicating a HARQ buffering capability, as described above.

As further shown in FIG. 11, in some aspects, process 1100 may include transmitting a HARQ process quantity configuration in accordance with the UE capability report (block 1120). For example, the network node (e.g., using transmission component 1304 and/or communication manager 1306, depicted in FIG. 13) may transmit a HARQ process quantity configuration in accordance with the UE capability report, as described above.

Process 1100 may include additional aspects, such as any single aspect or any combination of aspects described below and/or in connection with one or more other processes described elsewhere herein.

In a first aspect, the HARQ process quantity configuration configures one or more HARQ processes on a set of CCs, and a quantity of CCs of the set of CCs does not satisfy a CC quantity threshold, and a UE supports a per-CC maximum quantity of HARQ processes on each CC of the quantity of CCs, or the quantity of CCs satisfies the CC quantity threshold, and the UE supports, on each CC of the quantity of CCs, fewer HARQ processes than the per-CC maximum quantity of HARQ processes.

In a second aspect, alone or in combination with the first aspect, the UE capability report further indicates a maximum quantity of HARQ processes supported on a serving cell.

In a third aspect, alone or in combination with one or more of the first and second aspects, the HARQ process quantity configuration is in accordance with the HARQ buffering capability.

In a fourth aspect, alone or in combination with one or more of the first through third aspects, the HARQ process quantity configuration is in accordance with the HARQ buffering capability and configures a quantity of HARQ processes that exceeds the maximum quantity of HARQ processes.

In a fifth aspect, alone or in combination with one or more of the first through fourth aspects, downlinking scheduling aggregated across downlink CCs satisfies the HARQ buffering capability.

In a sixth aspect, alone or in combination with one or more of the first through buffering capability.

In a seventh aspect, alone or in combination with one or more of the first through sixth aspects, the HARQ buffering capability includes one or more of a maximum per-CC HARQ buffer size or a maximum aggregate HARQ buffer size across the plurality of CCs, and the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

In an eighth aspect, alone or in combination with one or more of the first through seventh aspects, the HARQ process quantity configuration configures, for a downlink CC, a quantity of HARQ processes that exceeds a per-CC maximum quantity of HARQ processes or an aggregate maximum quantity of HARQ processes across the plurality of CCs, and downlink scheduling aggregated across downlink CCs satisfies the maximum per-CC HARQ buffer size.

In a ninth aspect, alone or in combination with one or more of the first through eighth aspects, the HARQ process quantity configuration configures, for a downlink CC, a quantity of HARQ processes that exceeds a per-CC maximum quantity of HARQ processes or an aggregate maximum quantity of HARQ processes across the plurality of CCs, and pending HARQ retransmissions for the downlink CC satisfy the maximum per-CC HARQ buffer size.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a UE capability report indicating a maximum quantity of HARQ processes supported across a plurality of CCs or indicating a HARQ buffering capability. The reception component 1202 may receive a HARQ process quantity configuration in accordance with the UE capability report.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1302 and/or the transmission component 1304 may include or May be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a UE capability report indicating a maximum quantity of HARQ processes supported across a plurality of CCs or indicating a HARQ buffering capability. The transmission component 1304 may transmit a HARQ process quantity configuration in accordance with the UE capability report.

The number and arrangement of components shown in FIG. 13 are provided as an example. In practice, there may be additional components, fewer components, different components, or differently arranged components than those shown in FIG. 13.

Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting a UE capability report indicating a maximum quantity of hybrid automatic repeat request (HARQ) processes supported across a plurality of component carriers (CCs) or indicating a HARQ buffering capability; and receiving a HARQ process quantity configuration in accordance with the UE capability report.

Aspect 2: The method of Aspect 1, wherein the HARQ process quantity configuration configures one or more HARQ processes on a set of CCs, and wherein a quantity of CCs of the set of CCs does not satisfy a CC quantity threshold, and the UE supports a per-CC maximum quantity of HARQ processes on each CC of the set of CCs, or wherein the quantity of CCs satisfies the CC quantity threshold, and the UE supports, on each CC of the set of CCs, fewer HARQ processes than the per-CC maximum quantity of HARQ processes.

Aspect 3: The method of any of Aspects 1-2, wherein the UE capability report further indicates a maximum quantity of HARQ processes supported on a serving cell of the UE.

Aspect 4: The method of any of Aspects 1-3, wherein the HARQ process quantity configuration is in accordance with the HARQ buffering capability.

Aspect 5: The method of any of Aspects 1-4, wherein the HARQ process quantity configuration is in accordance with the HARQ buffering capability and configures a quantity of HARQ processes that exceeds the maximum quantity of HARQ processes.

Aspect 6: The method of Aspect 5, wherein downlink scheduling aggregated across downlink CCs satisfies the HARQ buffering capability.

Aspect 7: The method of Aspect 5, wherein pending HARQ retransmissions across downlink CCs satisfy the HARQ buffering capability.

Aspect 8: The method of any of Aspects 1-7, wherein the HARQ buffering capability includes one or more of a maximum per-CC HARQ buffer size or a maximum aggregate HARQ buffer size across the plurality of CCs, and wherein the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

Aspect 9: The method of Aspect 8, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein downlink scheduling aggregated across downlink CCs satisfies the maximum per-CC HARQ buffer size.

Aspect 10: The method of Aspect 8, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein pending HARQ retransmissions for the downlink CC satisfy the maximum per-CC HARQ buffer size.

Aspect 11: A method of wireless communication performed by a network node, comprising: receiving a user equipment (UE) capability report indicating a maximum quantity of hybrid automatic repeat request (HARQ) processes supported across a plurality of component carriers (CCs) or indicating a HARQ buffering capability; and transmitting a HARQ process quantity configuration in accordance with the UE capability report.

Aspect 12: The method of Aspect 11, wherein the HARQ process quantity configuration configures one or more HARQ processes on a set of CCs, and wherein a quantity of CCs of the set of CCs does not satisfy a CC quantity threshold, and a UE supports a per-CC maximum quantity of HARQ processes on each CC of the quantity of CCs, or wherein the quantity of CCs satisfies the CC quantity threshold, and the UE supports, on each CC of the quantity of CCs, fewer HARQ processes than the per-CC maximum quantity of HARQ processes.

Aspect 13: The method of any of Aspects 11-12, wherein the UE capability report further indicates a maximum quantity of HARQ processes supported on a serving cell.

Aspect 14: The method of any of Aspects 11-13, wherein the HARQ process quantity configuration is in accordance with the HARQ buffering capability.

Aspect 15: The method of any of Aspects 11-14, wherein the HARQ process quantity configuration is in accordance with the HARQ buffering capability and configures a quantity of HARQ processes that exceeds the maximum quantity of HARQ processes.

Aspect 16: The method of Aspect 15, wherein downlink scheduling aggregated across downlink CCs satisfies the HARQ buffering capability.

Aspect 17: The method of Aspect 15, wherein pending HARQ retransmissions across downlink CCs satisfy the HARQ buffering capability.

Aspect 18: The method of any of Aspects 11-17, wherein the HARQ buffering capability includes one or more of a maximum per-CC HARQ buffer size or a maximum aggregate HARQ buffer size across the plurality of CCs, and wherein the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

Aspect 19: The method of Aspect 18, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein downlink scheduling aggregated across downlink CCs satisfies the maximum per-CC HARQ buffer size.

Aspect 20: The method of Aspect 18, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein pending HARQ retransmissions for the downlink CC satisfy the maximum per-CC HARQ buffer size.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
transmit a UE capability report indicating a maximum quantity of hybrid automatic repeat request (HARQ) processes supported across a plurality of component carriers (CCs) or indicating a HARQ buffering capability; and
receive a HARQ process quantity configuration in accordance with the UE capability report.

2. The apparatus of claim 1, wherein the HARQ process quantity configuration configures one or more HARQ processes on a set of CCs, and
wherein a quantity of CCs of the set of CCs does not satisfy a CC quantity threshold, and the UE supports a per-CC maximum quantity of HARQ processes on each CC of the set of CCs, or
wherein the quantity of CCs satisfies the CC quantity threshold, and the UE supports, on each CC of the set of CCs, fewer HARQ processes than the per-CC maximum quantity of HARQ processes.

3. The apparatus of claim 1, wherein the UE capability report further indicates a maximum quantity of HARQ processes supported on a serving cell of the UE.

4. The apparatus of claim 1, wherein the HARQ process quantity configuration is in accordance with the HARQ buffering capability.

5. The apparatus of claim 1, wherein the HARQ process quantity configuration is in accordance with the HARQ buffering capability and configures a quantity of HARQ processes that exceeds the maximum quantity of HARQ processes.

6. The apparatus of claim 5, wherein downlink scheduling aggregated across downlink CCs satisfies the HARQ buffering capability.

7. The apparatus of claim 5, wherein pending HARQ retransmissions across downlink CCs satisfy the HARQ buffering capability.

8. The apparatus of claim 1, wherein the HARQ buffering capability includes one or more of a maximum per-CC HARQ buffer size or a maximum aggregate HARQ buffer size across the plurality of CCs, and wherein the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

9. The apparatus of claim 8, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein downlink scheduling aggregated across downlink CCs satisfies the maximum per-CC HARQ buffer size.

10. The apparatus of claim 8, wherein the HARQ process quantity configuration configures, for a downlink CC, a quantity of HARQ processes that exceeds a per-CC maximum quantity of HARQ processes or an aggregate maximum quantity of HARQ processes across the plurality of CCs, and wherein pending HARQ retransmissions for the downlink CC satisfy the maximum per-CC HARQ buffer size.

11. A method of wireless communication performed by a user equipment (UE), comprising:
transmitting a UE capability report indicating a maximum quantity of hybrid automatic repeat request (HARQ) processes supported across a plurality of component carriers (CCs) or indicating a HARQ buffering capability; and
receiving a HARQ process quantity configuration in accordance with the UE capability report.

12. The method of claim 11, wherein the HARQ process quantity configuration configures one or more HARQ processes on a set of CCs, and
wherein a quantity of CCs of the set of CCs does not satisfy a CC quantity threshold, and the UE supports a per-CC maximum quantity of HARQ processes on each CC of the set of CCs, or
wherein the quantity of CCs satisfies the CC quantity threshold, and the UE supports, on each CC of the set of CCs, fewer HARQ processes than the per-CC maximum quantity of HARQ processes.

13. The method of claim 11, wherein the UE capability report further indicates a maximum quantity of HARQ processes supported on a serving cell of the UE.

14. The method of claim 11, wherein the HARQ process quantity configuration is in accordance with the HARQ buffering capability.

15. The method of claim 11, wherein the HARQ process quantity configuration is in accordance with the HARQ buffering capability and configures a quantity of HARQ processes that exceeds the maximum quantity of HARQ processes.

16. The method of claim 15, wherein downlink scheduling aggregated across downlink CCs satisfies the HARQ buffering capability.

17. The method of claim 15, wherein pending HARQ retransmissions across downlink CCs satisfy the HARQ buffering capability.

18. The method of claim 11, wherein the HARQ buffering capability includes one or more of a maximum per-CC HARQ buffer size or a maximum aggregate HARQ buffer size across the plurality of CCs, and wherein the HARQ process quantity configuration configures a quantity of HARQ processes that exceeds the maximum quantity of HARQ processes across downlink CCs and satisfies the maximum per-CC HARQ buffer size or the maximum aggregate HARQ buffer size.

19. An apparatus for wireless communication, comprising:
means for transmitting a capability report indicating a maximum quantity of hybrid automatic repeat request (HARQ) processes supported across a plurality of component carriers (CCs) or indicating a HARQ buffering capability; and
means for receiving a HARQ process quantity configuration in accordance with the capability report.

20. The apparatus of claim 19, wherein the HARQ process quantity configuration configures one or more HARQ processes on a set of CCs, and
wherein a quantity of CCs of the set of CCs does not satisfy a CC quantity threshold, and the apparatus supports a per-CC maximum quantity of HARQ processes on each CC of the set of CCs, or
wherein the quantity of CCs satisfies the CC quantity threshold, and the UE supports, on each CC of the set of CCs, fewer HARQ processes than the per-CC maximum quantity of HARQ processes.
